(19) United States
(12) Patent Application Publication
(10) Pub. No.: US 2024/0356213 A1
(43) Pub. Date: Oct. 24, 2024

(54) Isotropic Positioning System

(71) Applicant: christopher kyricos, Marshfield, MA (US)

(72) Inventor: christopher kyricos, Marshfield, MA (US)

(21) Appl. No.: 18/636,250

(22) Filed: Apr. 15, 2024

(51) Int. Cl. H01Q 3/08; H01Q 15/16

(52) U.S. Cl. CPC H01Q 3/08; H01Q 15/16

(57) ABSTRACT

The invention points a beam of an electromagnetic frequency to any point in space without blocking its optical axis, capable of generating a spherical radiation pattern, approximately doubling the angular range compared to all directional antenna systems. Emulating a perfect isotropic radiator which until now, was considered impossible, it uses standard motion control and telecommunication technology.

A powered structure rotating within a sphere.

### CROSS-REFERENCE TO RELATED APPLICATIONS

Not Applicable

### FEDERALLY SPONSORED RESEARCH

Not Applicable

### BACKGROUND OF THE INVENTION

### 1. Field of the Invention

The present invention relates to a powered structure rotatable within a sphere able to orient an electromagnetic beam to any point in three dimensional space without obstructing its optical axis.

### 2. Description of Related Art

It has been the object of known apparatus adapted to perform the task of rotating a platform about a horizontal and vertical axis. In addition, when the platform supports an apparatus producing a directional beam of a specified electromagnetic frequency, it is desirable that positioning the beam to a point or through any series of points occurs with absolute angular range and without obstruction to its optical axis.

### SUMMARY OF THE INVENTION

According to the present invention, a spherical enclosure contains a structure making contact with its interior with at least two points of contact and the spheres center point lie on the same line. For illustrative purposes herein described, an internal structure is shown making rolling contact within its interior surface at three points forming a plane containing the center point of the sphere. By example, three powered omnidirectional wheels make contact at three points in the spheres interior and provide stable, unrestricted motion to orient the inner structure to any point in space.

The inner structure can be equipped with any component to provide an electromagnetic beam oriented to any point in space without obstruction to its optical axis. The system receives power from contact with the sphere, wirelessly or by highly resonant electromagnetic induction.

### BRIEF DESCRIPTION OF THE DRAWINGS

The preferred embodiments of a spherical apparatus comprising an inner structure to rotate about any axis will now be discussed in detail. The embodiments depict a novel and non-obvious inner structure contained within a stationary sphere, shown in the accompanying drawings, which are for illustrative purposes only. These drawings include the following figures, in which like numerals indicate like parts:

FIG. 1 is a perspective view of the sphere and its inner structure.

FIG. 2 is an exploded view shown in FIG. 1.

FIG. 3 represents an imaginary plane slicing the spherical apparatus shown in FIG. 1.

FIG. 4 is a cross sectional view of the FIG. 3, depicted by view A-A.

FIG. 5 is a close-up of FIG. 4, detailing the angular relationship between parts.

FIG. 6 is a close-up view of the top enclosure surfaces removed to expose a close of view between the spherical outer structure and inner structure contact point and sensor.

FIGS. 7, 8, 9 and 10 illustrate the various conditions in which wheel rotation accounts for all positions of the inner structure.

### DETAILED DESCRIPTION OF THE PREFERRED EMBODIMENTS

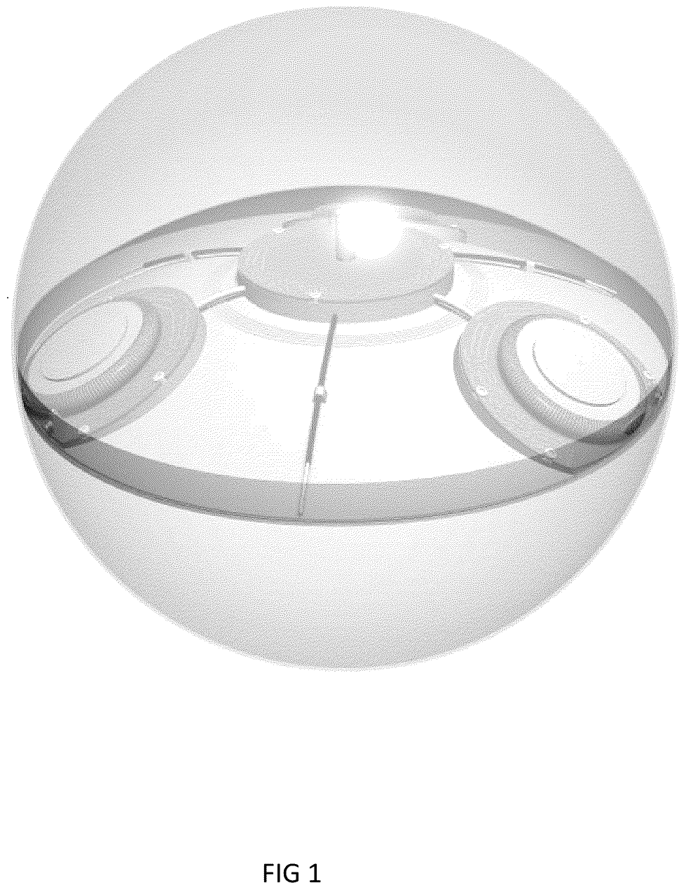

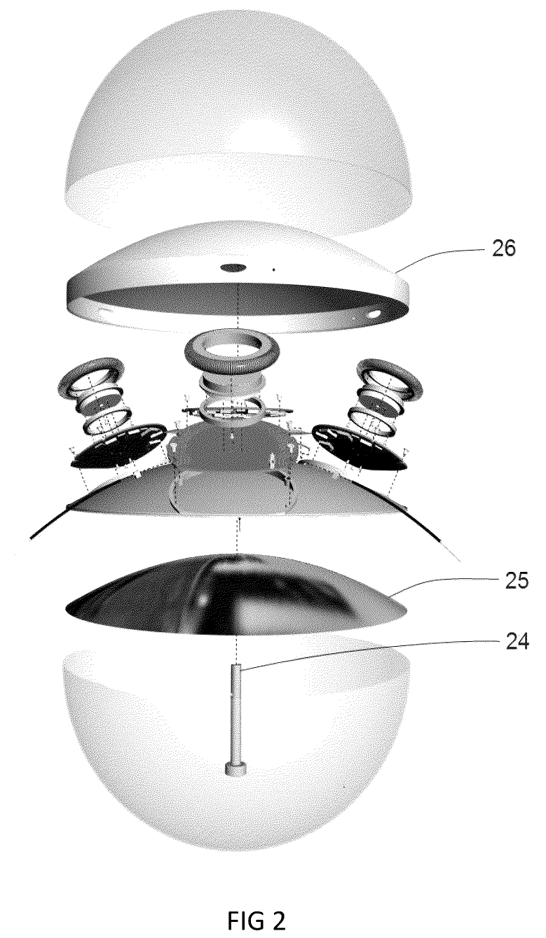

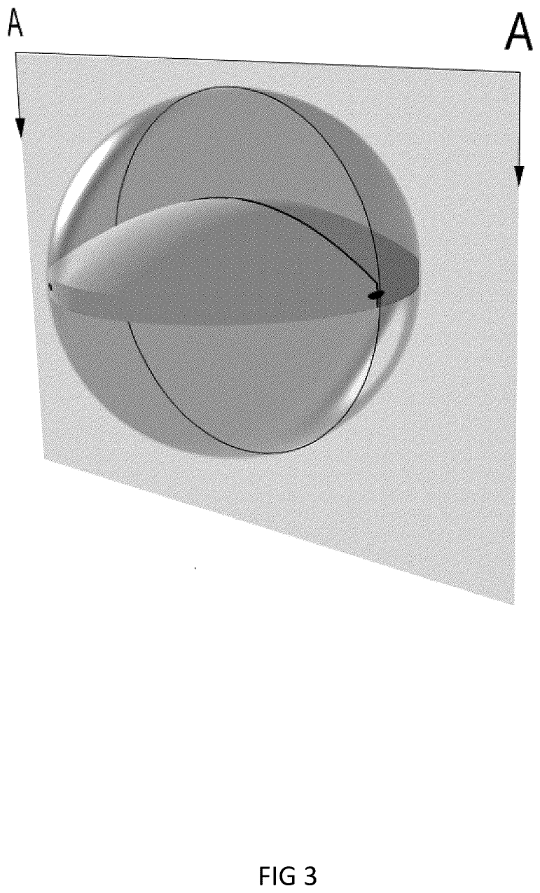

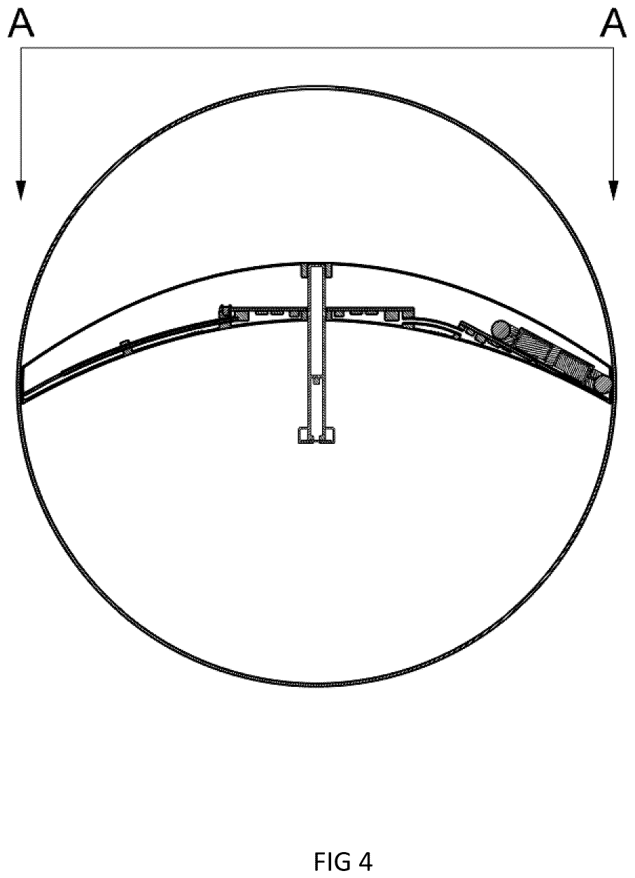

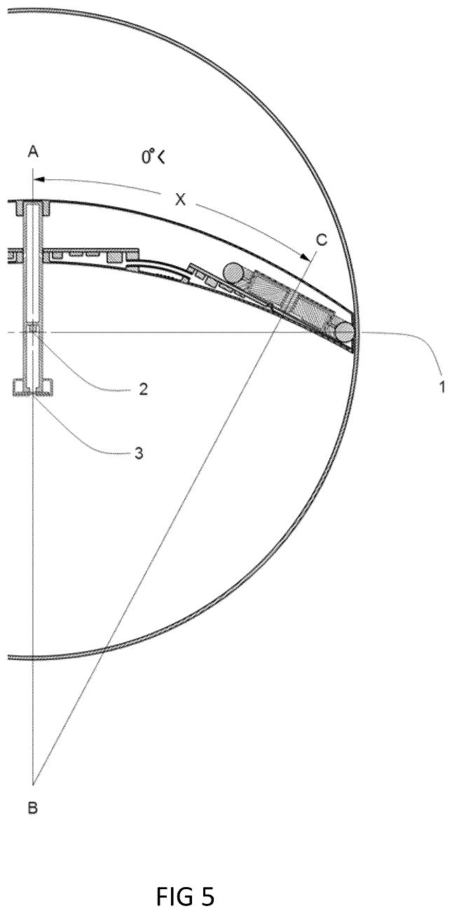

Referring to FIG. 1, there is an outer sphere shown to be transparent to illustrate its inner structure. Its transparency in practical terms, is composed of a material invisible to the electromagnetic frequencies desired to be transmitted through it.

Referring to FIG. 5 it is shown that item 1 points to a cross sectional view of a contact point between an omnidirectional wheel and the inside of the spherical enclosure. Integrated within the hub of the omnidirectional wheel is the shaft of an electric motor. The angle of the rotational axis of motor shaft C-B relative to centerline B-A is greater than zero degrees and less than ninety degrees.

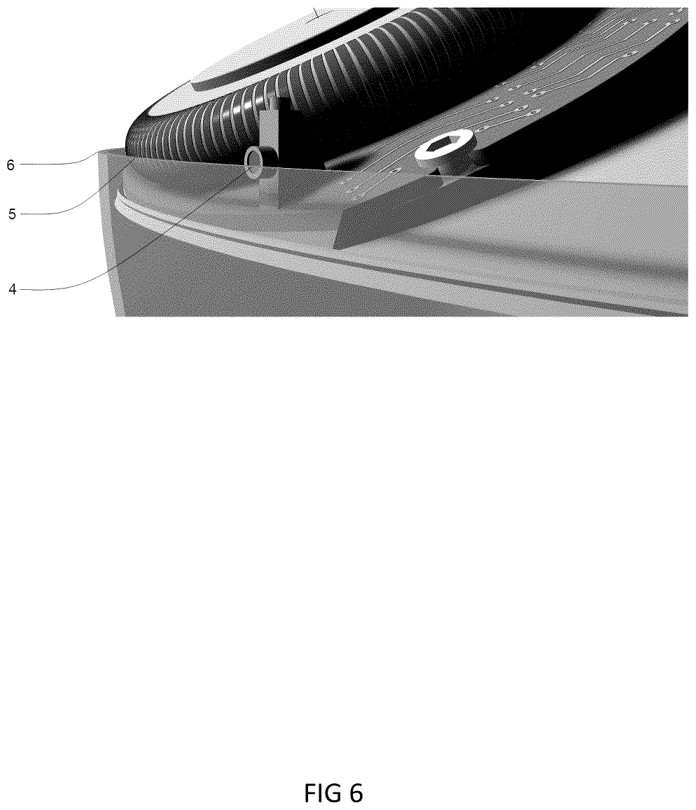

Referring to FIG. 6. Contact point 1 referred to in FIG. 5 is represented as 5. Item 4 represents an optical sensor to detect movement within the interior surface of 6. Sensor 4 is a well-known component referred to as a dark-field illumination laser sensor often used in optical mice to detect motion on polished surfaces. Other high-resolution sensors are acceptable.

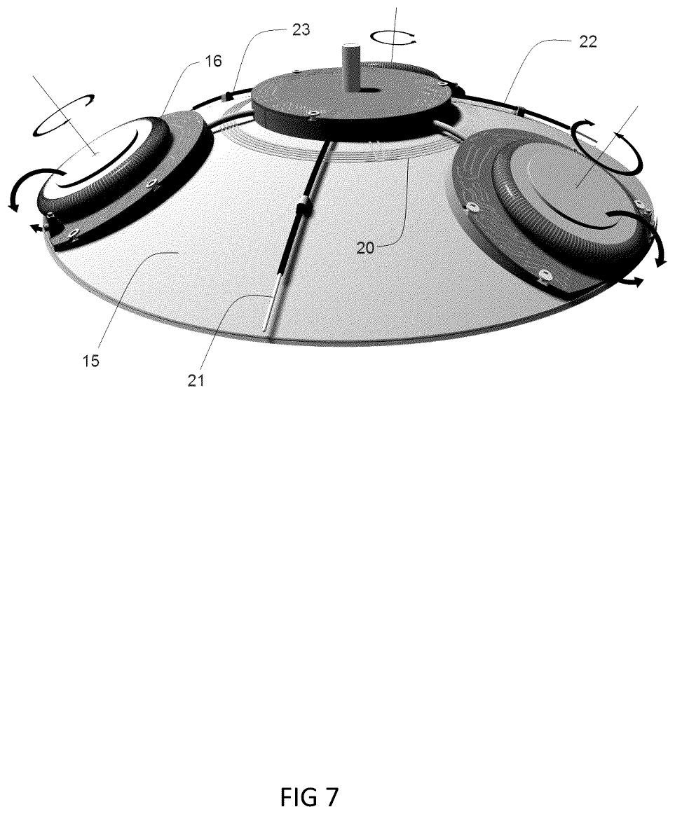

Referring FIG. 7 is a representation of three motorized omnidirectional wheels affixed to platform 15, showing both rotation and counter-rotation indicated by solid arrows. It is well known that such wheels provide traction without sliding, provide rotations radially, axially or both.

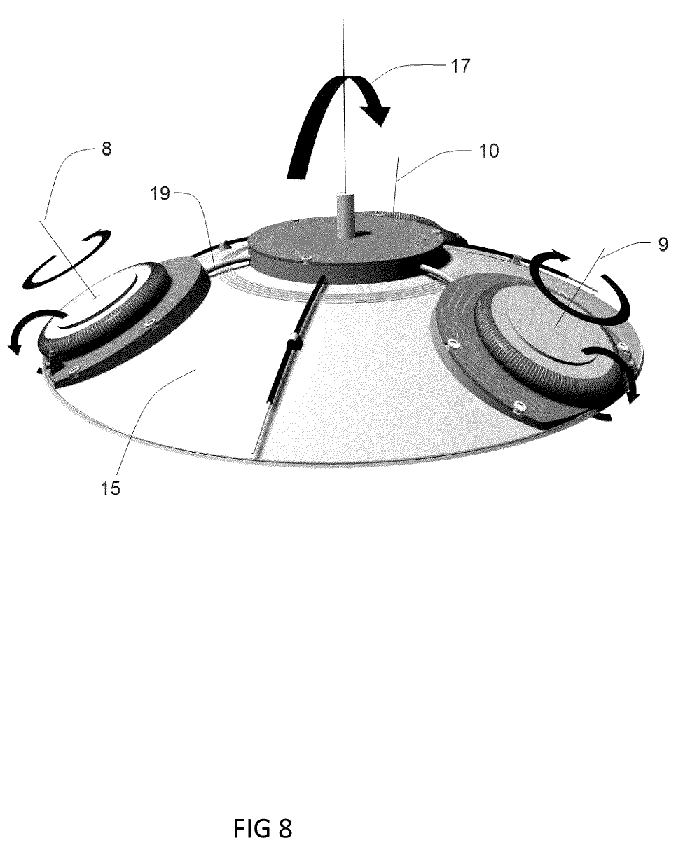

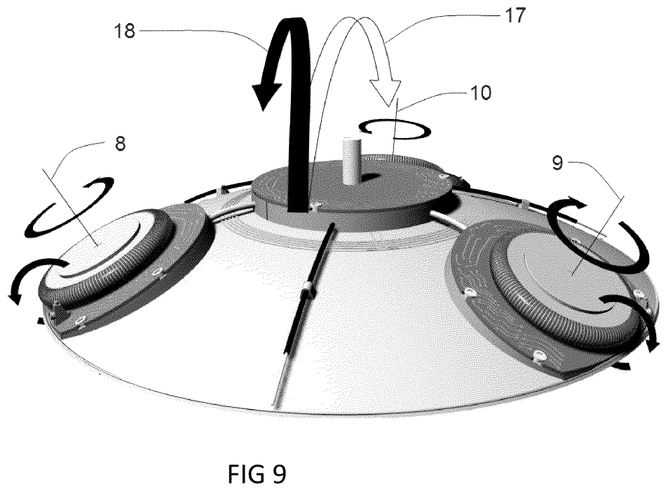

Referring to FIG. 8, the net result of each motors rpm collectively move 15 along a unique vector path along the interior surface of sphere 5 in FIG. 6. In the condition illustrated in FIG. 8, when motors 8 and 9 rotate in opposite direction while motor 10 does not rotate, platform 15 moves in the direction of arrow 17.

Referring to FIG. 9, when motors 8 and 9 rotate in opposite direction while motor 10 rotates, platform 15 moves in the direction of arrow 18.

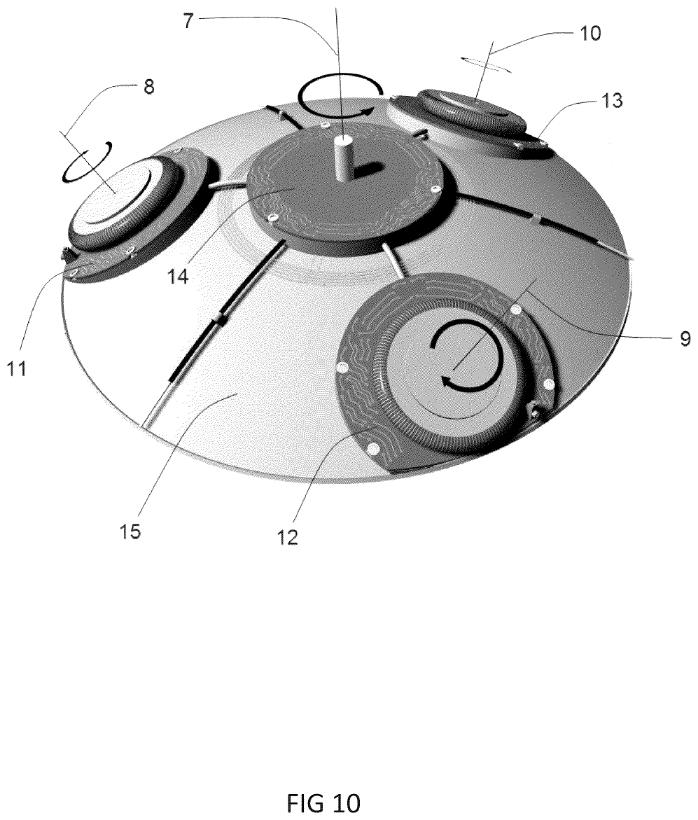

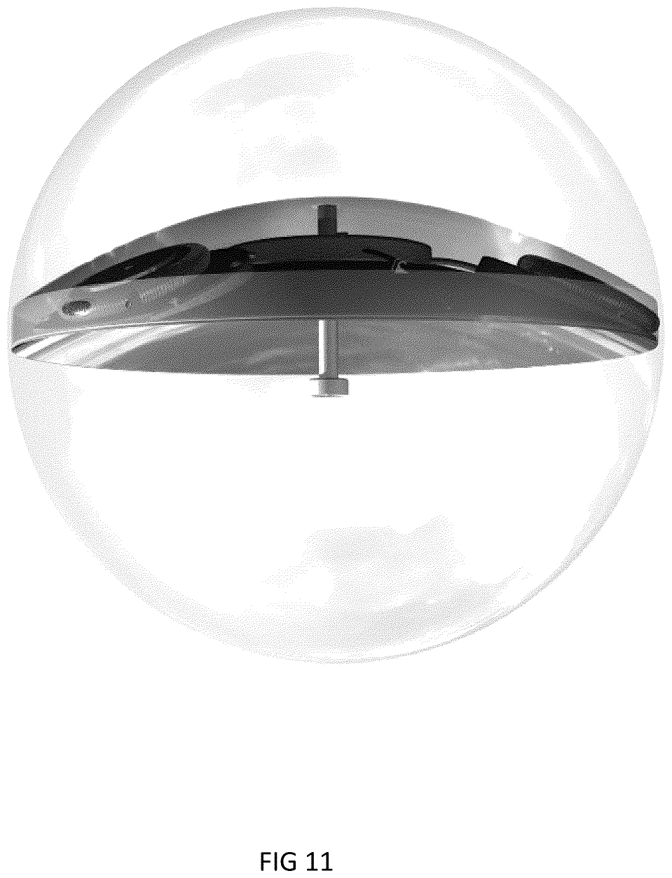

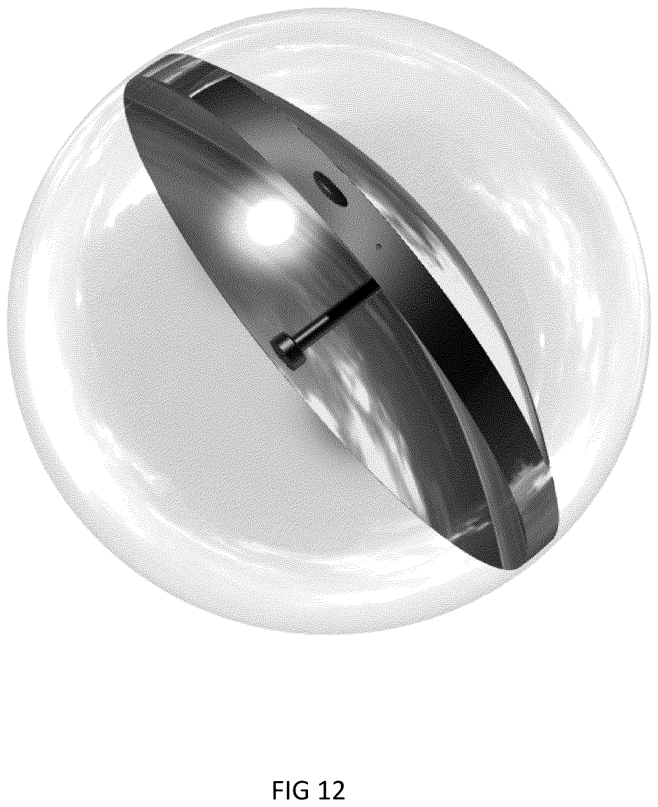

Referring to FIG. 10, when motors 8, 9 and 10 move in the same direction, platform 15 rotates around axis 7 as indicated by the arrow.

The above conditions are examples enabling one to conclude that the orientation positions of platform 15 is without limit.

The most reliable positional accuracy of 15 can be expected given that contact with the outermost surface of the invention impart optimal mechanical advantage and that the structural rigidity inherent with a sphere is unsurpassed.

Referring to FIG. 7 is item 20, is a near-field-highly-resonant-magnetic-induction capture device that is familiar to those in the industry of power transmission. Near-field, highly-resonant induction is finding increasing use over the years for being developed to transmit power over distance. For this invention, it supplies all the power needed for motion control for the three powered omnidirectional wheels, sensors and the transceivers. The component which receives wireless energy is not a feature of this invention.

What is claimed is:

1. A sphere comprising:
1. A structure making at least two points of contact to the interior of the sphere.
2. An inner structure of claim 1 providing at least two points of rolling contact.
3. The rolling contact of claim 2 can be powered.
4. Each wheel of claim 3 rotates around its own axis.
5. The rotational axis in claim 4 comprising an angular relationship to a line running perpendicular to the inner structure of claim 2 that is greater than zero degrees and not greater than 90 degrees as depicted in FIG. 5.
6. The inner structure of claim 1 comprising the means to direct a beam of a specified electromagnetic frequency to any point in space in three-dimensional space or through any series of points in three dimensional space over distances simultaneously with omni-directional transmission of the same frequency over shorter distances.
7. Sphere comprising inner structure of claim 1 composed of material predominantly transparent to the electromagnetic frequencies used.
8. An inner structure of claim 2 and claim 6 receives power remotely or through physical contact with the sphere.
